(19) United States
(12) Patent Application Publication
(10) Pub. No.: US 2017/0033631 A1
(43) Pub. Date: Feb. 2, 2017

(54) METHOD FOR ROEBEL TRANSPOSITION OF FORM WOUND CONDUCTORS OF ELECTRICAL MACHINES SUCH AS GENERATORS AND MOTORS

(71) Applicant: Siemens Energy, Inc., Orlando, FL (US)

(72) Inventor: Douglas James Conley, Charlotte, NC (US)

(21) Appl. No.: 14/811,891

(22) Filed: Jul. 29, 2015

(51) Int. Cl. H02K 3/14; H02K 15/04

(52) U.S. Cl. CPC H02K 3/14; H02K 15/04

(57) ABSTRACT

A method for Roebel transposition of form wound conductors for electrical machines is disclosed which creates less distortion of strand geometry and more efficiently stacks the conductor strands. The transposition involves four stacks of conductors, where two conductor strands from a top position in the first two adjacent stacks of conductors are transposed side-by-side two places to a top position in the other two adjacent stacks of conductors, with a corresponding downward shift in the second two stacks and upward shift in the first two stacks. Compared to a traditional Roebel pattern involving only two stacks of conductors and transposing two vertically-adjacent strands, the four-stack side-by-side Roebel transposition method produces a stack height which is reduced by one strand, and reduces the likelihood of strand-to-strand short circuits because of the smoother transition geometry involved.

### BACKGROUND OF THE INVENTION

Field of the Invention

This invention relates generally to a method for Roebel transposition of conductors in electrical machine and, more particularly, to a Roebel transposition which involves four stacks of conductors, where two conductor strands from a top position in a first two adjacent stacks of conductors are transposed side-by-side two places to a top position in the other two adjacent stacks of conductors.

Description of the Related Art

Electrical machines, such as generators and motors, have been serving the needs of society for well over a hundred years. As the performance and reliability of generators and motors improved, the designs naturally grew in size to meet the demands of larger and larger applications. For example, multi-megawatt generators have been developed which produce electrical power for utility companies.

When generators are made large in size and operated at high power settings, losses caused by eddy currents and circulating currents in the windings can become significant. The windings of these generators typically consist of multiple conductor strands insulated separately and stacked into bars. The conductor strands can be transposed, using a technique called Roebel transposition, to different positions along a set of conductor stacks. By ensuring that each individual strand transitions to different positions along the length of the stack, Roebel transposition has been shown to be effective in suppressing losses caused by eddy currents and circulating currents.

However, Roebel transposition requires deformation of the conductor strands which can create high-stress contact points between strands, leading to increased likelihood of insulation damage and strand-to-strand short circuits. Roebel transposition also creates voids between the conductor strands, thereby reducing the efficiency of the stacked strands of bars.

### SUMMARY OF THE INVENTION

In accordance with the teachings of the present invention, a method for Roebel transposition of form wound conductors for electrical machines is disclosed which creates less distortion of strand geometry and more efficiently stacks the conductor strands. The transposition involves four stacks of conductors, where two conductor strands from a top position in the first two adjacent stacks of conductors are transposed side-by-side two places to a top position in the other two adjacent stacks of conductors, with a corresponding downward shift in the second two stacks and upward shift in the first two stacks. Compared to a traditional Roebel pattern involving only two stacks of conductors and transposing two vertically-adjacent strands, the four-stack side-by-side Roebel transposition method produces a stack height which is reduced by one strand, and reduces the likelihood of strand-to-strand short circuits because of the smoother transition geometry involved.

Additional features of the present invention will become apparent from the following description and appended claims, taken in conjunction with the accompanying drawings.

### BRIEF DESCRIPTION OF THE DRAWINGS

FIG. 1 is an illustration of a typical generator stator including a plurality of slots;

FIG. 2 is a close-up illustration of the stator of FIG. 1 showing a typical arrangement of windings in a slot;

FIG. 3 is an illustration of stator winding bars which are formed using a traditional Roebel transposition pattern;

FIG. 4 is a schematic diagram showing the position of each individual conductor strand at each transposition in the traditional Roebel pattern of FIG. 3;

FIG. 5 is an illustration of stator winding bars which are formed using a new side-by-side double-Roebel transposition pattern as disclosed herein;

FIG. 6 is a schematic diagram showing the position of each individual conductor strand at each transposition in the new side-by-side double-Roebel pattern of FIG. 5; and

FIG. 7 is a flowchart diagram of a method for transposing strands in a conductor bar for a winding of an electrical machine.

### DETAILED DESCRIPTION OF THE EMBODIMENTS

The following discussion of the embodiments of the invention directed to method for Roebel transposition of conductors in electrical machines is merely exemplary in nature, and is in no way intended to limit the invention or its applications or uses. For example, the Roebel transposition pattern is discussed below in the context of a generator or motor stator, but may be applicable to any winding in rotating machinery.

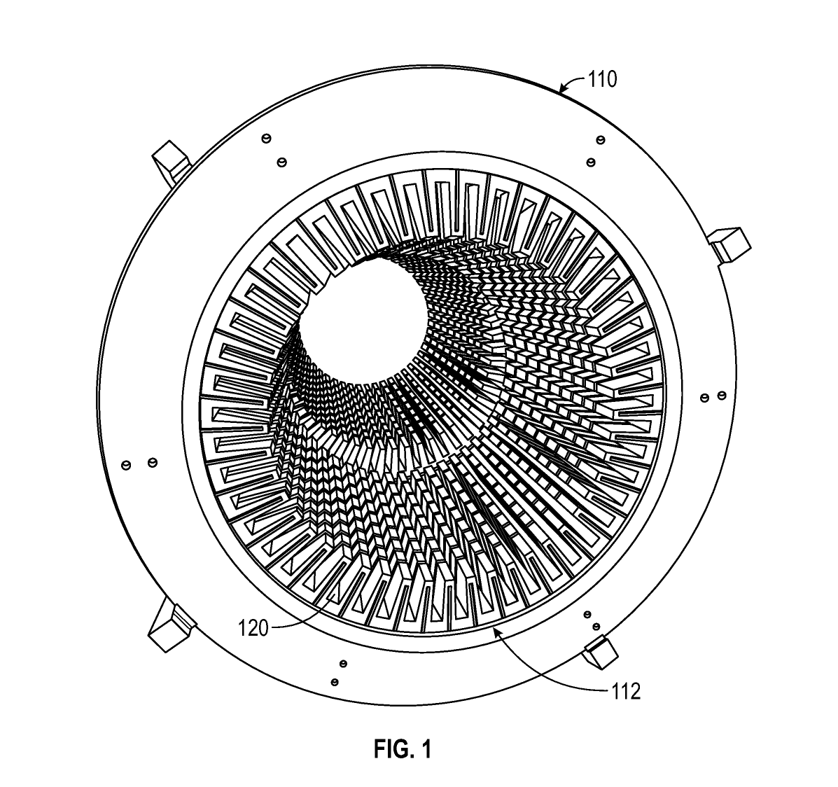

FIG. 1 is an illustration of a stator 110 from a typical large industrial generator. The stator 110 includes a core 112 with a plurality of slots 120 which receive windings which run from end to end of the stator 110, back and forth through the slots 120. The windings are typically comprised of straight sections of conductor bar (discussed in detail below) running through the slots 120, connected by end windings at the ends of the stator 110. The end windings loop around to provide connectivity between a conductor bar in one slot and a conductor bar in another slot. The conductor bars are typically comprised of numerous individual conductor strands, while the end windings may electrically consolidate all of the individual strands into a single solid conductor. A generator rotor (not shown) is situated in the central opening of the stator, where the rotor is driven by a turbine or other device, and electricity is produced by the generator. The core 112 is typically made up of a plurality of thin elements, such as ferrous stampings, assembled together into a laminate structure.

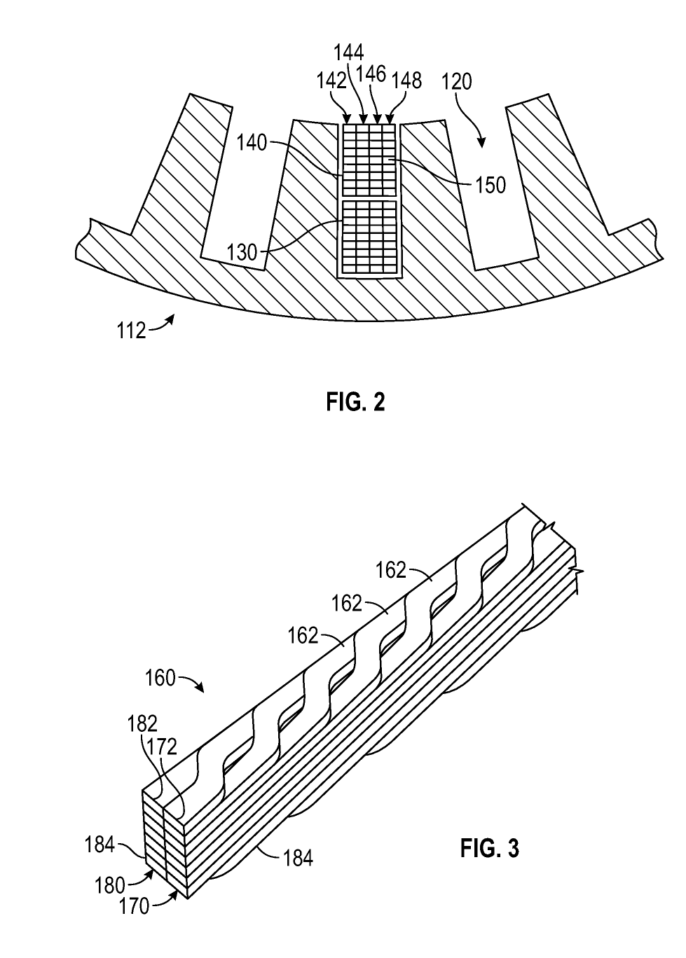

FIG. 2 is a close-up cross-sectional illustration of the core 112 of the stator 110 showing a typical arrangement of windings in one of the slots 120. In one exemplary embodiment of the stator 110, each of the slots 120 includes a bottom half-coil or conductor bar 130 and a top half-coil or conductor bar 140, which are independent of each other. The top bar 140 includes four stacks (142,144,146,148) of conductor strands 150. Likewise for the bottom bar 130. Each of the conductor strands 150 is rectangular in cross-section, with a width greater than a thickness, with rounded corners and an exterior insulation (not shown). The four stacks (142,144,146,148) are typically separated by a thin stack separator material, and may have a height ranging from approximately five to fifteen (or more) conductor strands, resulting in a total of 20-60 (or more) of the conductor strands 150 in the bar 140. The bars 130 and 140 may have a cross-sectional size of about two inches square (more or less) for a large generator, and a length of 100-300 inches.

Although the stacks (142-148) of strands 150 are shown in FIG. 2 as being a uniform rectangular grid, in reality the strands 150 must be transposed to different positions in the stacks 142-148 as they move along the length of the stator 110. This transposition, which causes each conductor strand to occupy both interior and exterior positions along the length of the conductor bar, is necessary in large electrical machines in order to minimize detrimental eddy currents and circulating currents in the conductors. The transposition creates an effect similar to twisting the bar 140 along its length, except that the transposition must be done in a way that maintains the horizontal orientation of each of the strands 150 and the rectangular shape of the bar 140. Roebel transposition is a technique typically used to transpose conductor strand position along the length of the bars (130,140) in the stator 110.

FIG. 3 is an illustration of a stator winding bar 160 which is formed using a traditional Roebel transposition pattern. The bar 160 includes individual strands 162 formed into two stacks, identified as 170 and 180. The stacks 170 and 180 are seven strands high in this example; more or fewer strands could be used in each of the stacks 170 and 180. At the left side of FIG. 3, a strand 172 occupies the topmost position in the stack 170, and a strand 182 occupies the topmost position in the stack 180. This left end of the bar 160 may be known as “Position 0” for reference. Moving along the length of the bar 160, a transposition then occurs which shifts the strand 182 downward one position and shifts the strand 172 over to the top of the stack 180, directly above the strand 182. At the same location, all of the other strands in the stack 170 shift upward one position, and all of the other strands in the stack 180 (except for a strand 184) shift downward one position. The strand 184, which was at the bottom of the stack 180 at Position 0, shifts over to the bottom of the stack 170, thus completing the transposition to Position 1. Six more such shifts or transpositions are shown in FIG. 3, where each transposition follows the same pattern of strands moving down the stack 180 and up the stack 170.

FIG. 3 only shows a portion of the length of the bar 160, for illustration purposes. In reality, the bar 160 would continue on for some additional distance following the same pattern. In one common design, over the full length of the stator and the bar 160, each of the strands 162 would undergo a complete cycle around all fourteen positions in the stacks 170 and 180. This complete cycle is typically referred to as a 360° transposition (one full turn). Depending on the size of the stator, the strand size and other factors, other transposition designs may also be used—such as 540° (one and a half turns) or 720° (two full turns). Also, as shown in FIG. 2, a complete bar may include four stacks. The bar 160 of FIG. 3 only shows two stacks (170 and 180)—but two additional stacks may be included in the bar 160, where the two additional stacks would be interwoven with each other but independent of the stacks 170 and 180.

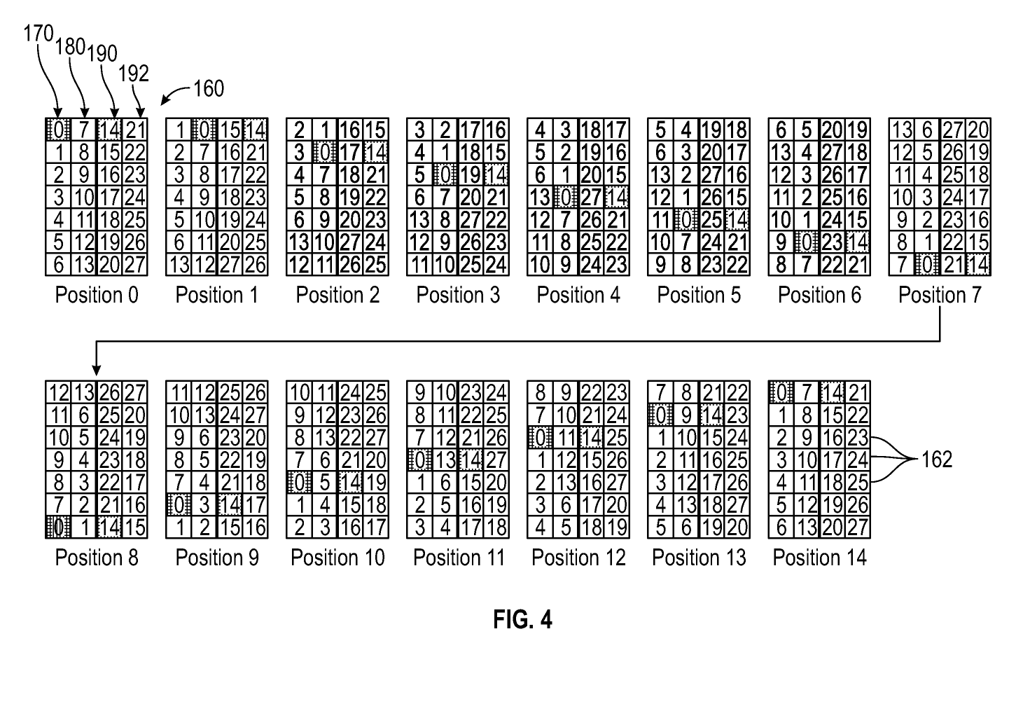

FIG. 4 is a schematic diagram showing the position of each individual conductor strand 162 at each transposition in the traditional Roebel pattern of FIG. 3. FIG. 4 shows a cross-section of the bar 160 as viewed from the “back” of the stator 110; that is, FIG. 4 shows the bar 160 as viewed from the right-hand end of FIG. 3. Beginning with Position 0 at the upper left of FIG. 4, a cross-section of the bar 160 shows the stacks 170 and 180 shown in FIG. 3 and discussed above, along with two additional stacks 190 and 192. In the traditional Roebel transposition pattern shown in FIG. 4, the stacks 170 and 180 are interwoven with each other but not with the stacks 190 and 192. That is, the traditional Roebel transposition pattern involves only two stacks; therefore, in a four-stack wide bar, the first two adjacent stacks are woven together, and the second two adjacent stacks are woven together independently of the first two stacks.

In FIG. 4, each of the strands is given a number, so that the location of each strand can be followed from position to position. Position 0 represents the positions of the strands 162 in the bar 160 at the left-hand end of FIG. 3. At Position 0, from top to bottom, the stack 170 consists of strands number 0-6, the stack 180 consists of strands number 7-13, the stack 190 consists of strands number 14-20, and the stack 192 consists of strands number 21-27.

Continuing from left to right across the top row of FIG. 4, it can be seen how the strands rotate positions in their two-stack sets as they go along the length of the bar 160. For example, moving from Position 0 to Position 1, strand 0 shifts from the top of the stack 170 to the top of the stack 180, strand 7 moves from the top of the stack 180 downward one position, and strand 13 moves from the bottom of the stack 180 to the bottom of the stack 170. Moving through the 15 positions (0-14), at each transposition the individual strands 162 move downward in the stack 180 and upward in the stack 170, with crossover from the stack 170 to the stack 180 at the top and crossover from the stack 180 to the stack 170 at the bottom. The same pattern occurs independently in the stacks 190 and 192. Strands 0 and 14 are highlighted to assist in the visual recognition of the strand transposition pattern, continuing to Position 14 which completes the 360° transposition (one full turn).

FIG. 4 includes a number of cross-sectional “snapshots” of the conductor strand positions along the length of the bar 160. What cannot be seen in FIG. 4 (and is partially apparent in FIG. 3) is that the shifting of conductor strands from one stack to the next creates irregularities in the rectangular stacks, including stress concentrating contact points and voids in the stacks. This is particularly true in the case of a known variation of the Roebel transposition pattern where the top two strands from one stack (not just the top one strand as in FIGS. 3 and 4) are shifted to the top of the adjacent stack. This vertical double-Roebel transposition pattern is used to more quickly rotate each strand around the positions in the bar, particularly in stacks with a large number of strands (>10). Although the vertical double-Roebel transposition reduces the number of positions by half, it creates larger voids at the transitions and therefore increases the stack height for a given number of strands, and it also necessitates more distortion of the strands and thereby creates more uneven strand-to-strand contact.

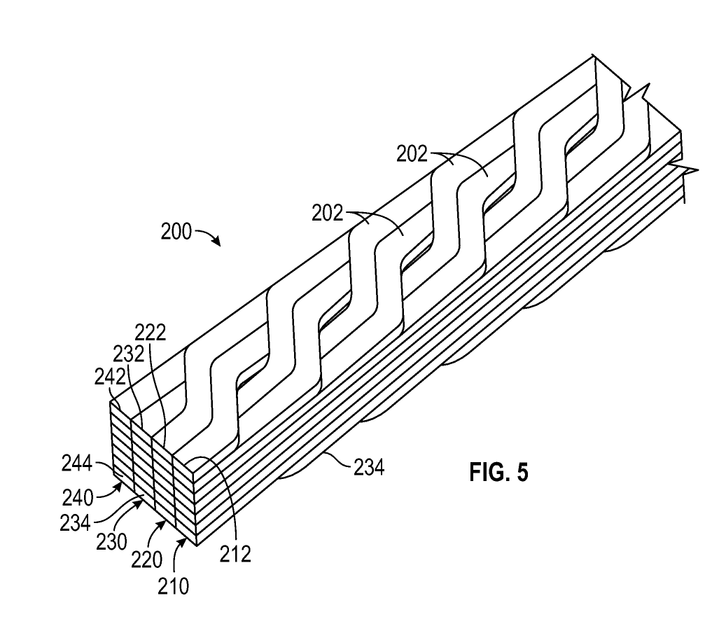

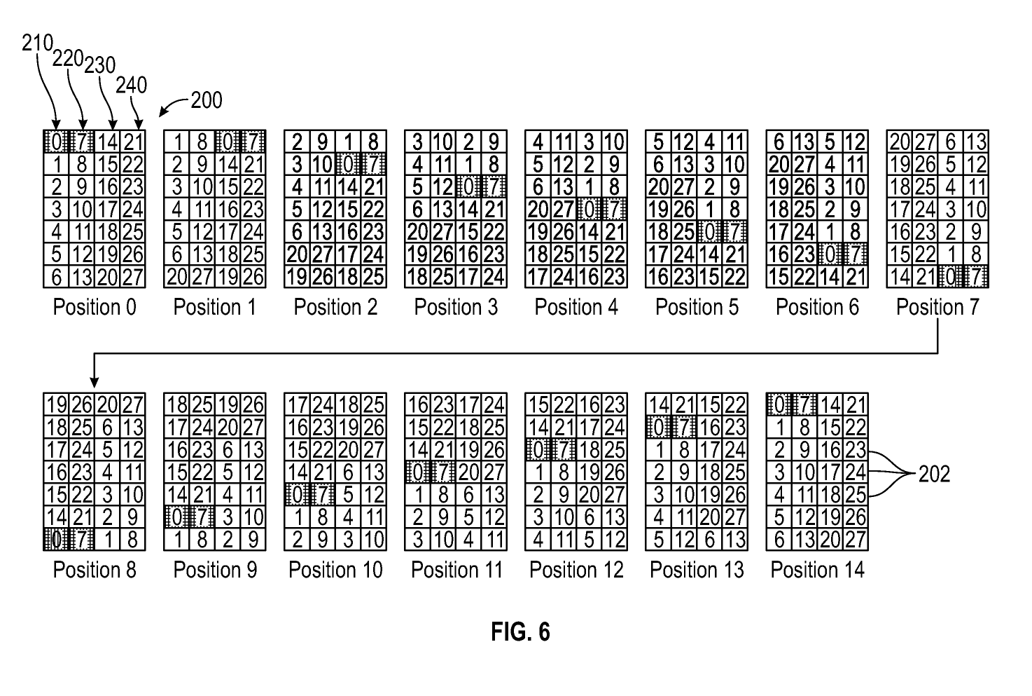

FIG. 5 is an illustration of a stator winding bar 200 which is formed using a new side-by-side double-Roebel transposition pattern as disclosed herein. The side-by-side double-Roebel transposition pattern of FIG. 5 (and also FIG. 6, discussed below) does not take two strands from the top of one stack and move them to the adjacent stack, but rather takes the top strand from each of two adjacent stacks and moves those two top strands to the next two adjacent stacks. Thus, this side-by-side double-Roebel transposition pattern produces a four-stack bar which is completely inter-woven, whereas traditional Roebel patterns produce a “left-side” two stacks which are interwoven and a “right-side” two stacks which are interwoven but the left-side two stacks and the right-side two stacks are independent.

In Figures, four stacks (210,220,230,240) of conductors 202 comprise a bar 200. The stacks 210-240 are again seven strands high in this example. At the left side of FIG. 5, a strand 212 occupies the topmost position in the stack 210, a strand 222 occupies the topmost position in the stack 220, a strand 232 occupies the topmost position in the stack 230, and a strand 242 occupies the topmost position in the stack 240. This left end of the bar 200 is again referred to as “Position 0”. Moving along the length of the bar 200, a transposition then occurs which shifts the strands 232 and 242 downward one position and shifts the strands 212 and 222 over to the top of the stacks 230 and 240, respectively, directly above the strands 232 and 242. At the same time, all of the other strands in the stacks 210 and 220 shift upward one position, and all of the other strands in the stacks 230 and 240 (except for strands 234 and 244) shift downward one position. The strands 234 and 244, which were at the bottom of the stacks 230 and 240, respectively, at Position 0, shifts over to the bottom of the stacks 210 and 220, respectively, thus completing the transposition to Position 1.

Four more such shifts or transpositions are shown in FIG. 5, where each transposition follows the same pattern of strands moving down the stacks 230 and 240, and up the stacks 210 and 220. FIG. 5 shows only a portion of the bar 200. Along its full length, each of the strands 202 in the bar 200 would undergo at least one full turn (360° transposition).

FIG. 6 is a schematic diagram showing the position of each individual conductor strand 202 at each transposition in the new side-by-side double-Roebel pattern of FIG. 5. FIG. 6 shows a cross-section of the bar 200 as viewed from the “back” of the stator 110; that is, FIG. 6 shows the bar 200 as viewed from the right-hand end of FIG. 5. As in FIG. 4 discussed above, each of the strands 202 in FIG. 6 is given a location number 0-27, which begin at Position 0 in order from top to bottom and left to right across the stacks 210,220,230,240. That is, at Position 0, from top to bottom, the stack 210 consists of strands number 0-6, the stack 220 consists of strands number 7-13, the stack 230 consists of strands number 14-20, and the stack 240 consists of strands number 21-27.

Continuing from left to right across the top row of FIG. 6, it can be seen how the 202 strands rotate positions through the four stacks 210-240. For example, moving from Position 0 to Position 1, strands 0 and 7 shift from the top of the stacks 210 and 220 to the top of the stacks 230 and 240, respectively. At the same time, strands 14 and 21 move from the top of the stacks 230 and 240 downward one position, and strands 20/27 move from the bottom of the stacks 230/240 to the bottom of the stacks 210/220. Moving through the 15 positions (0-14), at each transposition the individual strands 202 move downward in the stacks 230/240 and upward in the stacks 210/220, with crossover from the stacks 210/220 to the stacks 230/240 at the top and crossover from the stacks 230/240 to the stacks 210/220 at the bottom. Strands 0 and 7 are highlighted to assist in the visual recognition of the strand transposition pattern, continuing to Position 14 which completes the 360° transposition (one full turn).

The new side-by-side double-Roebel transposition pattern shown in FIGS. 5 and 6 provides several advantages over traditional Roebel transposition patterns. In the traditional Roebel transposition pattern shown in FIGS. 3 and 4, the strands in the stacks 170 and 180 are transposed independently of the stacks 190 and 192. This means that any individual strand 162 can only occupy its original (Position 0) stack or the next adjacent stack. In the side-by-side double-Roebel transposition pattern of FIGS. 5 and 6, each individual conductor strand 202 traverses three of the four stacks in the bar 200, rather than just two of the four stacks as in prior art methods. By having each conductor traverse back and forth across more of the bar 200, side-by-side double-Roebel transposition pattern is more effective than traditional Roebel transposition at reducing the eddy currents and circulating currents which are detrimental to performance in large electrical machines.

Another advantage of the side-by-side double-Roebel transposition pattern is that this pattern produces less vertical void space in the stack, particularly when compared to the vertical double-Roebel transposition pattern discussed above in connection with FIG. 4. The vertical double-Roebel transposition involves moving the top two strands from one stack to the next at each transposition. This causes the stacks, at each transposition point, to have a height which is two strands greater than the number of strands in each stack. This increased vertical void space in the vertical double-Roebel transposition pattern creates a bar which requires a greater volume for a given amount of conductor cross-sectional area, thereby reducing the volumetric efficiency of the windings in the stator. On the other hand, the side-by-side double-Roebel transposition pattern uses only a single vertical transposition at each step, thereby having a stack height which is one strand less than the stack height of the vertical double-Roebel transposition pattern, resulting in increased volumetric efficiency of the windings in the stator.

Still another advantage of the side-by-side double-Roebel transposition pattern is that this pattern produces less uneven contact between strands in the stack, particularly when compared to the vertical double-Roebel transposition pattern discussed above. Because the vertical double-Roebel transposition involves moving the top two strands from one stack to the next at each transposition, individual strands are subjected to significant deformation at each step. These strand deformations—both in the vertical and horizontal directions—cause uneven points of contact between the strands, with high contact loads or stress concentrations at the contact points. The stress concentrations at the contact points in the vertical double-Roebel transposition increase the likelihood of strand-to-strand short circuits in the windings. It is well known that strand-to-strand short circuits cause performance and reliability problems in electrical machines, and can be difficult to detect and repair. On the other hand, the side-by-side double-Roebel transposition pattern involves only a single vertical transposition at each step, thereby reducing stress concentrations and the likelihood of strand-to-strand short circuits in the windings of the stator.

The side-by-side double-Roebel transposition pattern shown in FIGS. 5 and 6 involves four stacks of conductors, which is a preferred embodiment. However, the same side-by-side double-Roebel transposition technique could be applied to stator bars which include more than four stacks of conductors, such as six or eight stack bars.

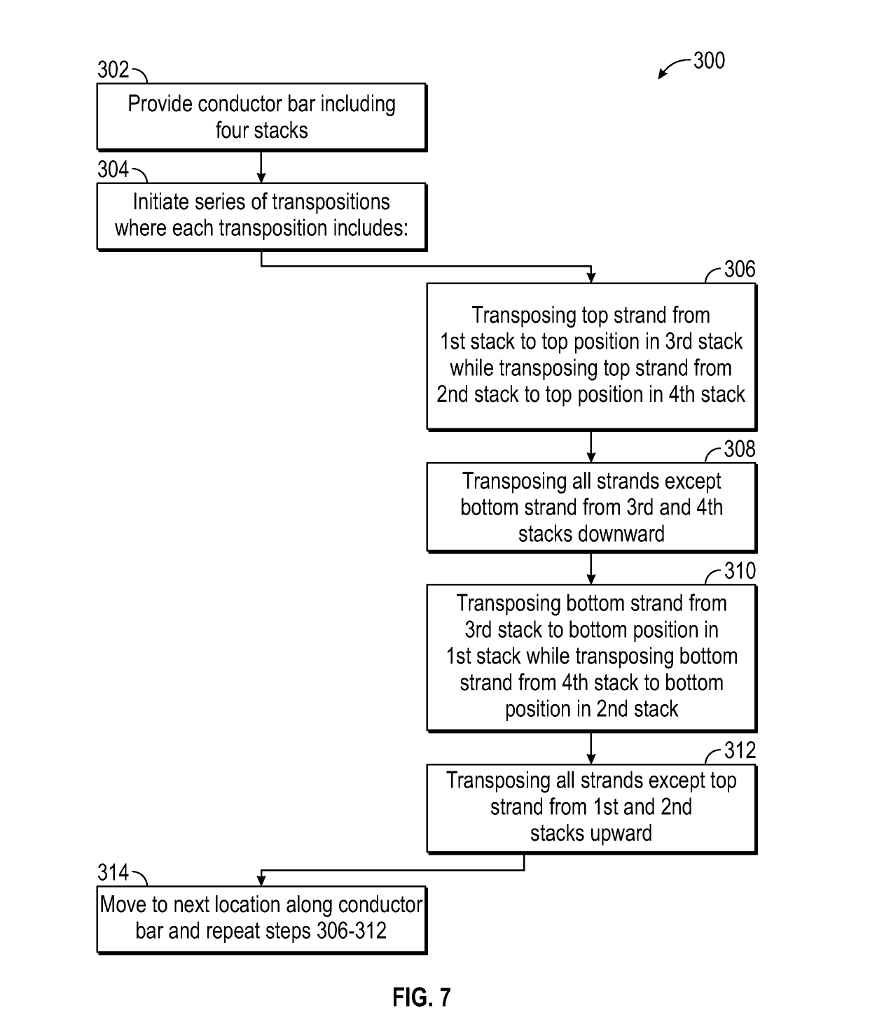

FIG. 7 is a flowchart diagram 300 of a method for transposing strands in a conductor bar for a winding of an electrical machine, using the side-by-side double-Roebel transposition pattern discussed above. At box 302, a bar comprising four side-by-side stacks of conductors is provided, where each of the stacks includes a plurality of individual conductor strands stacked vertically. The four stacks include a first stack located at a first side of the conductor bar, a second stack adjacent to the first stack, a third stack adjacent to the second stack, and a fourth stack adjacent to the third stack and located at a second side of the conductor bar. At box 304, a series of transpositions are then initiated, where each of the transpositions includes the following steps.

At box 306, a top strand from the first stack is transposed to a top position in the third stack while a top strand from the second stack is transposed to a top position in the fourth stack. At box 308, occurring at a same location along a length of the bar as the step of the box 306, all strands except a bottom strand in the third stack and the fourth stack are transposed downward by one strand thickness. At box 310, occurring at the same location along the length of the bar as the steps of the boxes 306 and 308, the bottom strand from the third stack is transposed to a bottom position in the first stack while the bottom strand from the fourth stack is transposed to a bottom position in the second stack. At box 312, occurring at the same location along the length of the bar as the steps of the boxes 306-310, all strands except the top strand in the first stack and the second stack are transposed upward by one strand thickness.

At box 314, the transposition steps of the boxes 306-312 are repeated at uniform intervals along the length of the conductor bar until each of the conductor strands has undergone a prescribed amount of positional rotation within the bar, where the prescribed amount of rotation may be one full turn, one-and-a-half turns, or two full turns over the length of the bar.

The side-by-side double-Roebel transposition pattern disclosed above achieves the reduction of eddy currents and circulating currents in the windings which is necessary in large electrical machines, while providing advantages including an increased range of positions occupied by each conductor strand, reduced stress concentration and likelihood of strand-to-strand short circuits, and reduced overall stack height. The advantages of the side-by-side double-Roebel transposition pattern enable the production of electrical machines with increased efficiency and reliability, which are beneficial to both the electrical machine manufacturers and customers.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A conductor bar for a winding of an electrical machine, said conductor bar comprising:
four side-by-side stacks of conductors, where each of the stacks includes a plurality of individual conductor strands stacked vertically, and where the four stacks include a first stack located at a first side of the conductor bar, a second stack adjacent to the first stack, a third stack adjacent to the second stack, and a fourth stack adjacent to the third stack and located at a second side of the conductor bar,
where, at uniform intervals along a length of the conductor bar, a side-by-side double-Roebel transposition of the conductor strands occurs such that;
a top strand from the first stack is transposed to a top position in the third stack while a top strand from the second stack is transposed to a top position in the fourth stack,
all strands except a bottom strand in the third stack and the fourth stack are transposed downward by one strand thickness,
the bottom strand from the third stack is transposed to a bottom position in the first stack while the bottom strand from the fourth stack is transposed to a bottom position in the second stack, and
all strands except the top strand in the first stack and the second stack are transposed upward by one strand thickness.

2. The conductor bar of claim 1 wherein the transposition of the conductor strands occurs repeatedly at the uniform intervals along the length of the conductor bar until each of the conductor strands has undergone a prescribed amount of positional rotation within the conductor bar.

3. The conductor bar of claim 2 wherein the prescribed amount of positional rotation is one full turn, one-and-a-half turns, or two full turns over the length of the conductor bar.

4. The conductor bar of claim 1 wherein the individual conductor strands are composed of copper, have a rectangular cross-sectional shape with rounded corners and a width greater than a height, and are covered with insulating material.

5. The conductor bar of claim 1 wherein at least one pair of adjacent stacks is separated by a stack separator.

6. The conductor bar of claim 1 wherein each of the four stacks includes 5-20 of the individual conductor strands.

7. The conductor bar of claim 1 wherein the conductor bar has a width of two to four inches, a height of two to four inches, and a length of 100-300 inches.

8. The conductor bar of claim 1 wherein the conductor bar is used in a stator of an electrical generator.

9. The conductor bar of claim 8 wherein the conductor bar makes up a bottom half-coil in a stator slot, and an identical conductor bar makes up a top half-coil in the stator slot.

10. The conductor bar of claim 9 wherein all of the individual conductor strands in the conductor bar are electrically consolidated into an end winding at both ends of the stator slot.

11. A stator for an electrical generator, said stator comprising:
a core including a plurality of slots oriented parallel to a central axis of the stator;
an upper conductor bar and a lower conductor bar in each of the slots, each of the conductor bars including four side-by-side stacks of conductors, where each of the stacks includes a plurality of individual conductor strands stacked vertically, and where the four stacks include a first stack located at a first side of the conductor bar, a second stack adjacent to the first stack, a third stack adjacent to the second stack, and a fourth stack adjacent to the third stack and located at a second side of the conductor bar,
where, at uniform intervals along a length of the conductor bar, a side-by-side double-Roebel transposition of the conductor strands occurs such that;
a top strand from the first stack is transposed to a top position in the third stack while a top strand from the second stack is transposed to a top position in the fourth stack,
all strands except a bottom strand in the third stack and the fourth stack are transposed downward by one strand thickness,
the bottom strand from the third stack is transposed to a bottom position in the first stack while the bottom strand from the fourth stack is transposed to a bottom position in the second stack, and
all strands except the top strand in the first stack and the second stack are transposed upward by one strand thickness; and
end windings at both ends of the stator which connect a conductor bar in one slot to a conductor bar in another slot.

12. The stator of claim 11 wherein the transposition of the conductor strands occurs repeatedly at the uniform intervals along the length of the conductor bar until each of the conductor strands has undergone a prescribed amount of positional rotation within the conductor bar.

13. The stator of claim 12 wherein the prescribed amount of positional rotation is one full turn, one-and-a-half turns, or two full turns over the length of the conductor bar.

14. The stator of claim 11 wherein the individual conductor strands are composed of copper, have a rectangular cross-sectional shape with rounded corners and a width greater than a height, and are covered with insulating material.

15. The stator of claim 11 wherein at least one pair of adjacent stacks is separated by a stack separator.

16. The stator of claim 11 wherein the individual conductor strands in the conductor bar are electrically consolidated in the end windings.

17. A method for transposing strands in a conductor bar for a winding of an electrical machine using a side-by-side double-Roebel transposition pattern, said method comprising:
providing a conductor bar comprising four side-by-side stacks of conductors, where each of the stacks includes a plurality of individual conductor strands stacked vertically, and where the four stacks include a first stack located at a first side of the conductor bar, a second stack adjacent to the first stack, a third stack adjacent to the second stack, and a fourth stack adjacent to the third stack and located at a second side of the conductor bar;
initiating a series of transpositions, where each of the transpositions includes the following transposition steps;
transposing a top strand from the first stack to a top position in the third stack while transposing a top strand from the second stack to a top position in the fourth stack;
transposing, at a same location along a length of the conductor bar as the previous step, all strands except a bottom strand in the third stack and the fourth stack downward by one strand thickness;
transposing, at the same location along the length of the bar as the previous two steps, the bottom strand from the third stack to a bottom position in the first stack while transposing the bottom strand from the fourth stack to a bottom position in the second stack; and
transposing, at the same location along the length of the bar as the previous three steps, all strands except the top strand in the first stack and the second stack upward by one strand thickness.

18. The method of claim 17 further comprising repeating the transposition steps at uniform intervals along the length of the conductor bar until each of the conductor strands has undergone a prescribed amount of positional rotation within the conductor bar, where the prescribed amount of positional rotation is one full turn, one-and-a-half turns, or two full turns over the length of the conductor bar.

19. The method of claim 17 wherein the individual conductor strands are composed of copper, have a rectangular cross-sectional shape with rounded corners and a width greater than a height, and are covered with insulating material.

20. The method of claim 17 wherein the conductor bar is used in a stator of an electrical generator.
